(19) United States
(12) Patent Application Publication
(10) Pub. No.: US 2013/0233993 A1
(43) Pub. Date: Sep. 12, 2013

(54) LADDER DOCKING STATION FOR USE WITH EXTENSION LADDERS

(71) Applicant: Daniel Edward Striepling, Muskego, WI (US)

(72) Inventor: Daniel Edward Striepling, Muskego, WI (US)

(21) Appl. No.: 13/798,058

(22) Filed: Mar. 12, 2013

Related U.S. Application Data
(60) Provisional application No. 61/609,753, filed on Mar. 12, 2012.

(51) Int. Cl. E06C 7/18

(52) U.S. Cl. CPC E06C 7/188
USPC 248/309.1

(57) ABSTRACT

A ladder docking station is attached to an extension ladder and, when leaned against the eave or gutter of a structure, provides a slip resistant contact surface. The same contact surface also protects against damage from the side rails of the ladder. The ladder docking station also provides a method for securing the ladder to the structure using built in hooks or optional nail holes. The ladder docking station eliminates the need for more than one product to solve side to side slipping, provide protection against damage from the side rails of the ladder, and provide methods for securing the ladder in place.

### CROSS-REFERENCE TO RELATED APPLICATION

This application claims the benefit of priority of U.S. provisional application No. 61/609,753, filed Mar. 12, 2012, the contents of which are herein incorporated by reference.

### BACKGROUND OF THE INVENTION

The present invention relates to ladder accessories and, more particularly, to a ladder docking station for use with extension ladders.

There are several problems users encounter when using extension ladders. First, the ladder can easily slip from side to side, especially if the user reaches over one side of the ladder. Further, the ladder can cause damage to the structure, such as to gutters, from its side rails. Moreover, conventional extension ladders are not attached to the structure and can move unexpectedly or unintentionally.

Conventional ladder accessories are designed for a single purpose and typically do not address all of the problems encountered when using extension ladders. Some conventional ladder accessories are poorly designed and do not function well and can be unreliable.

As can be seen, there is a need for a ladder accessory that can solve the problems associated with the use of conventional extension ladders, including the ability to slip from side to side, the ability to damage the structure, and the lack of ability to connect the ladder to the structure.

### SUMMARY OF THE INVENTION

In one aspect of the present invention, a ladder docking station comprises a body having a first thickness portion and a second thickness portion; a lip formed along a width of the body where the first thickness portion meets the second thickness portion; a handle slot cut into the first thickness portion; a recess cut into the second thickness portion, the recess having a width as least as wide as a width of a ladder, the recess forming wings on each side thereof; at least one strap slot cut into the second thickness portion; at least one strap slot strap passing through the at least one strap slot and operable to connect to a first rung of a ladder; and at least one handle slot strap passing through the handle slot and operable to connect to a second rung, one above the first rung, of the ladder.

In another aspect of the present invention, a ladder docking station comprises a body having a first thickness portion and a second thickness portion; a lip formed along a width of the body where the first thickness portion meets the second thickness portion; a handle slot cut into the first thickness portion; a recess cut into the second thickness portion, the recess having a width as least as wide as a width of a ladder, the recess forming wings on each side thereof; a first and a second strap slot disposed through the second thickness portion on opposite sides of the recess; strap slot straps passing through the first and second strap slots and operable to connect to a first rung of a ladder; at least one handle slot strap passing through the handle slot and operable to connect to a second rung, one above the first rung, of the ladder; resilient cords attached to wings on each side of the second thickness portion, the resilient cords having hooks on the ends thereof; and holes formed through the first thickness portion.

These and other features, aspects and advantages of the present invention will become better understood with reference to the following drawings, description and claims.

### BRIEF DESCRIPTION OF THE DRAWINGS

FIG. 1 is a perspective view of a ladder docking station, in use on an extension ladder, according to an exemplary embodiment of the present invention;

FIG. 2 is a top perspective view of the ladder docking station of FIG. 1;

FIG. 3 is a bottom perspective view of the ladder docking station of FIG. 1; and

FIG. 4 is a side view of the ladder docking station of Figure.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a ladder docking station that is attached to an extension ladder and, when leaned against the eave or gutter of a structure, provides a slip resistant contact surface. The same contact surface also protects against damage from the side rails of the ladder. The ladder docking station also provides a method for securing the ladder to the structure using built in hooks or optional nail holes. The ladder docking station eliminates the need for more than one product to solve side to side slipping, provide protection against damage from the side rails of the ladder, and provide methods for securing the ladder in place.

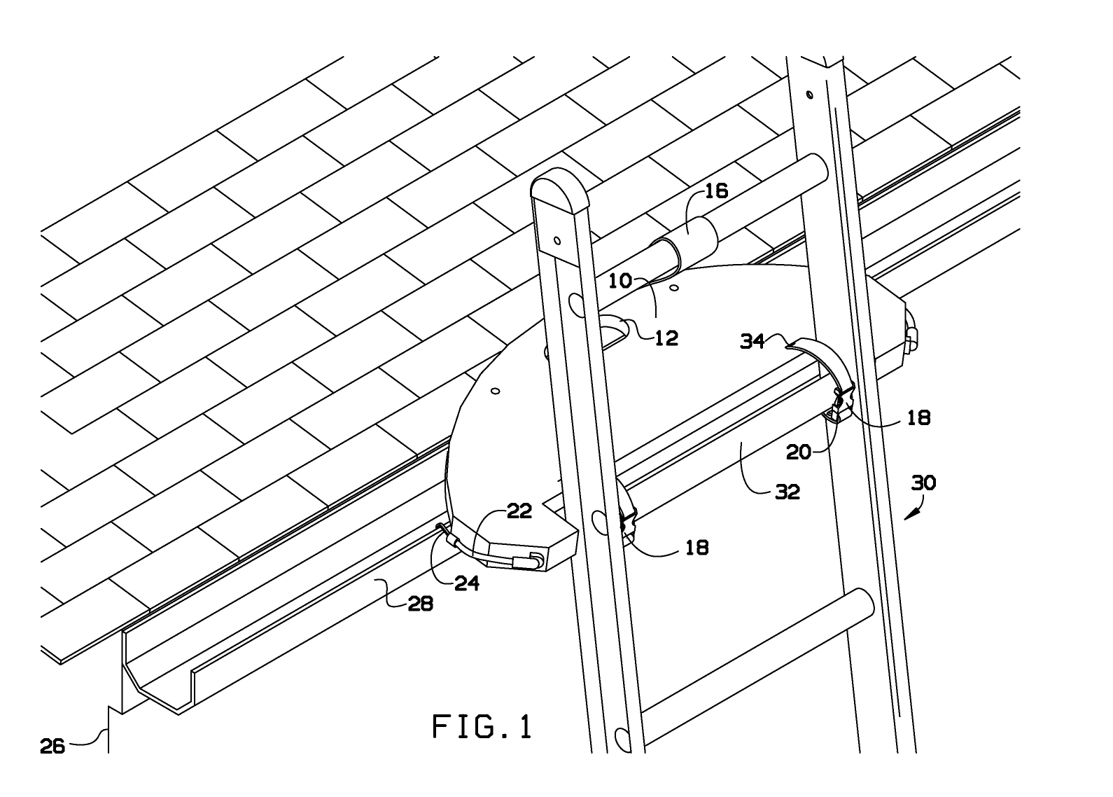

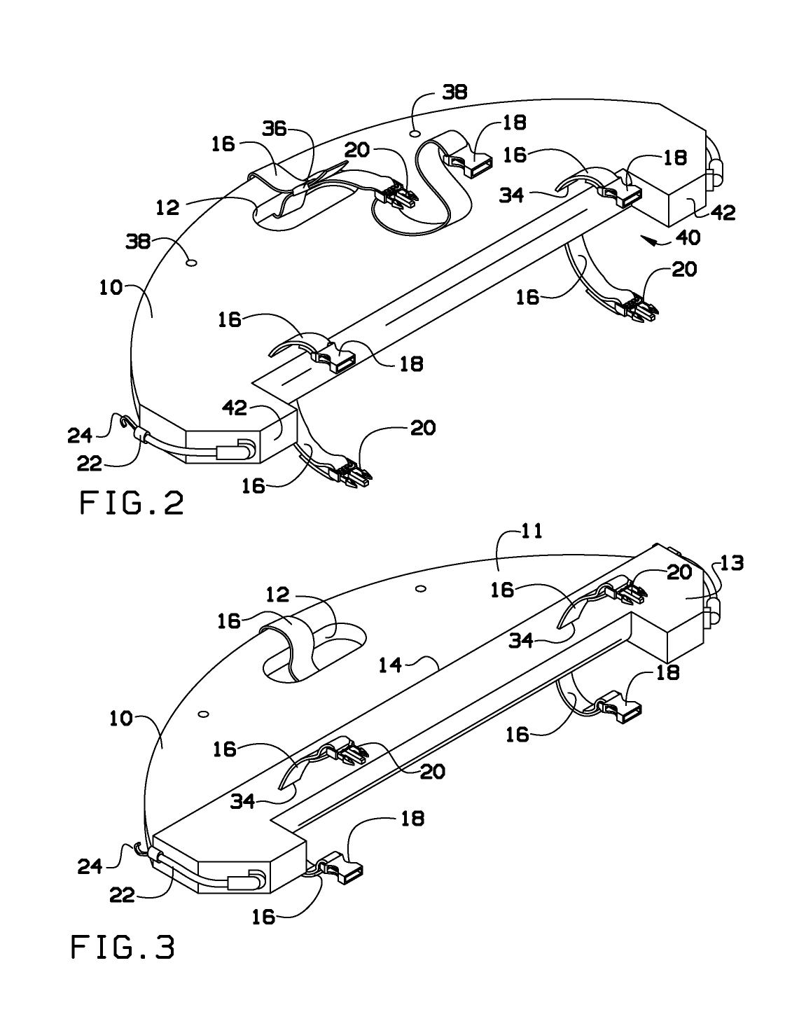

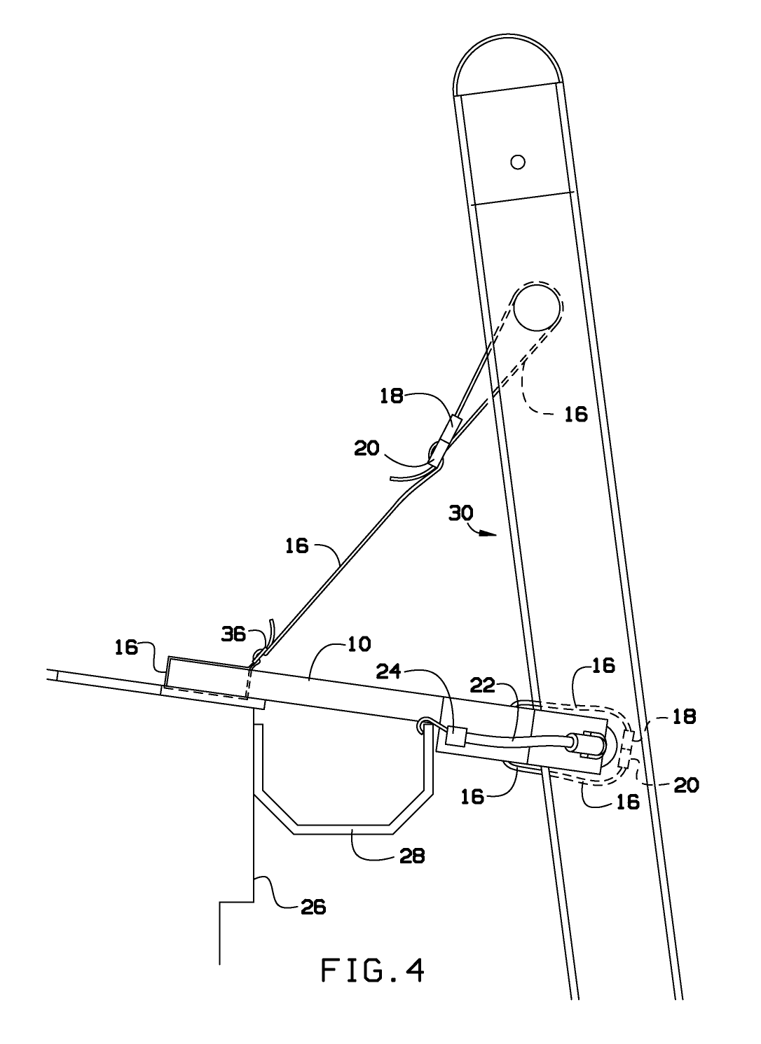

Referring now to FIGS. 1 through 4, a ladder docking station can include a body 10 having a lip 14 formed along a length of a bottom surface of the body 10. The lip 14 can divide the body 10 into a first thickness portion 11 and a second thickness portion 13.

The body 10 can be formed in various shapes and it typically is formed in a semi-circular or arced shape extending from the lip 14. The lip 14 can be from about ½ inch to about 1 inch, typically about ¾ inch in thickness from the first thickness portion 11. The lip 14 has a length that is longer than the width of a ladder 30 typically from about 26 inches to about 30 inches, usually about 28 inches.

A recess 40 can be cut into second thickness portion 13. The recess 40 can have a length that is about the same or slightly larger than the width of the ladder 30 so that wings 42 of the ladder docking station extend along the side of the rails of the ladder 30 as shown in FIG. 1.

A handle slot 12 can be cut in the first thickness portion 11 of the body 10. The handle slot 12 is placed generally centrally about the width of the first thickness portion 11 and at a maximum distance away from the lip 14. A strap 16 can adjustably attach to the handle slot 12 and extend therefrom. A female buckle 18 can be disposed on one end of the strap 16 and a male buckle 20 can be disposed at the other end of the strap 16.

At least one strap slot 34, typically two strap slots 34 can be formed in the second thickness portion 13 of the body 10. Typically, the strap slots 34 are disposed through the second thickness portion 13 near corners of the recess 40. Straps 16, having female and male buckles 18, 20, can be threaded through the strap slots 34.

The ladder docking station can be attached to the ladder 30 by placing the recess 40 on the structure-facing side of the ladder 30, with the lip 14 facing the ground, and securing the straps 16 extending through the strap slots 34 to a rung 32 of the ladder 30. Typically, the ladder docking station can be attached to the third run down from the top, although other positions are certainly possible.

The strap 16 through the handle slot 12 can then attach to the rung above the rung onto which the straps 16 extending through the strap slots 34 are attached. The length of the strap 16 through the handle slot 12 can be adjusted to provide a desired pitch, such as a 4/12 pitch. The ladder 30 can then be placed against the structure 26, with the lip 14 resting along an eave or gutter 38 of the structure 26. The full length of the lip 14 contacting the gutter 38 provides an anti-slip feature while protecting the structure from the rails of the ladder.

Each of the straps 16 can be adjustable straps and can be adjusted via various means known in the art. For example, a glide 36 can be provided to adjust the length of the straps 16.

From each of the wings 42 of the second thickness portion 13 of the body 10, a bungee-type cord 22 can be attached and extend therefrom. A hook 24 can be disposed on the end of the cord 22. The hook 24 can attach to the structure, such as to the gutter 38, to help secure the ladder docking station and the ladder 30.

Through holes 38 can be formed through the first thickness portion 11 of the body 10, typically at each side of the handle slot 12. The through holes 38 can provide a nail hole for attaching the ladder docking station to the structure 26. This can be especially useful where the hooks 24 on the cords 22 have nothing to attach.

The ladder docking station can be made from various materials in various processes. For example, the ladder docking station can be made from a rubber body, molded using recycled rubber materials that are compression formed in an aluminum mold. The straps 16 can be made of various materials, such as a fabric that is about 1 inch wide and about 23 inches long, for example.

It should be understood, of course, that the foregoing relates to exemplary embodiments of the invention and that modifications may be made without departing from the spirit and scope of the invention as set forth in the following claims.

What is claimed is:

1. A ladder docking station comprising:
a body having a first thickness portion and a second thickness portion;
a lip formed along a width of the body where the first thickness portion meets the second thickness portion;
a handle slot cut into the first thickness portion;
a recess cut into the second thickness portion, the recess having a width as least as wide as a width of a ladder, the recess forming wings on each side thereof;
at least one strap slot cut into the second thickness portion;
at least one strap slot strap passing through the at least one strap slot and operable to connect to a first rung of a ladder; and
at least one handle slot strap passing through the handle slot and operable to connect to a second rung, one above the first rung, of the ladder.

2. The ladder docking station of claim 1, wherein the at least one strap slot includes a first strap slot and a second strap slot.

3. The ladder docking station of claim 2, wherein the first strap slot and the second strap slot are disposed through the second thickness portion on opposite sides of the recess.

4. The ladder docking station of claim 1, further comprising resilient cords attached to wings on each side of the second thickness portion, the resilient cords having hooks on the ends thereof.

5. The ladder docking station of claim 1, further comprising through holes formed through the first thickness portion.

6. The ladder docking station of claim 1, wherein the handle slot strap is adjustable.

7. The ladder docking station of claim 1, wherein the second thickness portion is about ½ to 1 inch more thick than the first thickness portion.

8. A ladder docking station comprising:
a body having a first thickness portion and a second thickness portion;
a lip formed along a width of the body where the first thickness portion meets the second thickness portion;
a handle slot cut into the first thickness portion;
a recess cut into the second thickness portion, the recess having a width as least as wide as a width of a ladder, the recess forming wings on each side thereof;
a first and a second strap slot disposed through the second thickness portion on opposite sides of the recess;
strap slot straps passing through the first and second strap slots and operable to connect to a first rung of a ladder;
at least one handle slot strap passing through the handle slot and operable to connect to a second rung, one above the first rung, of the ladder;
resilient cords attached to wings on each side of the second thickness portion, the resilient cords having hooks on the ends thereof; and
holes formed through the first thickness portion.

9. The ladder docking station of claim 8, wherein the handle slot strap is adjustable.

10. The ladder docking station of claim 8, wherein the second thickness portion is about ½ to 1 inch more thick than the first thickness portion.
